(19) United States
(12) Patent Application Publication
(10) Pub. No.: US 2011/0161443 A1
(43) Pub. Date: Jun. 30, 2011

(54) DATA MANAGEMENT SYSTEMS AND METHODS FOR MOBILE DEVICES

(75) Inventors: Chin-Shyurng Fahn, Taipei City (TW); Chiu-Cheng Wang, Taipei City (TW)

(73) Assignee: NATIONAL TAIWAN UNIVERSITY OF SCIENCE & TECHNOLOGY, Taipei City (TW)

(21) Appl. No.: 12/874,050

(22) Filed: Sep. 1, 2010

(30) Foreign Application Priority Data
Dec. 30, 2009 (TW) TW98145748

(51) Int. Cl. G06F 15/16

(52) U.S. Cl. 709/206

(57) ABSTRACT

Data management systems and methods for mobile devices are provided. The system includes at least a mobile device and a management system. The mobile device at least includes an image capture unit for capturing an image, and a processing unit for transmitting the image to the management system via a network. The management system at least includes a processing unit for retrieving data corresponding to the image according to the received image, and transmitting the data corresponding to the image to the mobile device via the network.

### CROSS REFERENCE TO RELATED APPLICATIONS

This application claims priority of Taiwan Patent Application No. 098145748, filed on Dec. 30, 2009, the entirety of which is incorporated by reference herein.

### BACKGROUND OF THE INVENTION

1. Field of the Invention

The disclosure relates generally to data management systems and methods for mobile devices, and more particularly, to systems and methods that retrieve data according to an image captured by a mobile device via a network.

2. Description of the Related Art

Recently, due to the increased convenience of electronic devices, such as mobile devices, these devices have become basic necessities of life. Additionally, since the popularization of network architecture, related applications integrated with the electronic devices and networks have gradually become important.

For example, global mobile advertising is becoming more and more prevalent. Generally, an advertising company can transmit advertising information to mobile devices via networks. Conventionally, the advertising information is one-way. That is, the advertising information is not requested by the users of the mobile devices. Thus, for the advertising company, whether and how the advertising information is affecting users is unknown. Meanwhile, due to the large number of advertising information transmissions, network traffic may be congested and related costs may be high. Further, users may feel antipathy towards receiving a large number of unsolicited advertising information.

Therefore, there is a need for a management mechanism for related data such as advertising information based on user requirements, thus increasing the efficiency of data management and reducing the waste of resource usage.

### BRIEF SUMMARY OF THE INVENTION

Data management systems and methods for mobile devices are provided.

An embodiment of a data management system for mobile devices includes at least a mobile device and a management system. The mobile device at least includes an image capture unit for capturing an image, and a processing unit for transmitting the image to the management system via a network. The management system at least includes a processing unit for retrieving data corresponding to the image according to the received image, and transmitting the data corresponding to the image to the mobile device via the network.

An embodiment of a data management system for mobile devices includes at least a management system. The management system receives an image from a mobile device via a network. The management system retrieves data corresponding to the image according to the received image, and transmits the data corresponding to the image to the mobile device via the network.

In an embodiment of a data management method for mobile devices, an image is captured by a mobile device, and the image is transmitted to a management system via a network. After the image is received, the management system retrieves data corresponding to the image according to the received image, and transmits the data corresponding to the image to the mobile device via the network.

In an embodiment of a data management method for mobile devices, an image is received from a mobile device via a network. Data corresponding to the image is retrieved according to the received image, and the data corresponding to the image is transmitted to the mobile device via the network.

In some embodiments, the mobile device can pack the image as a message with a specific format, and transmit the message to the management system via the network.

In some embodiments, the management system can include a content database for storing data corresponding to respective image features. The management system can calculate a specific image feature corresponding to the image, and retrieve data corresponding to the image from the content database according to the specific image feature.

In some embodiments, the management system can record identification information corresponding to the mobile device and the data corresponding to the image, for subsequent management processes.

Data management methods for mobile devices may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a data management system for mobile devices of the invention;

FIG. 2 is a schematic diagram illustrating an embodiment of a mobile device of the invention;

FIG. 3 is a schematic diagram illustrating an embodiment of a management system of the invention;

FIG. 4 is a flowchart of an embodiment of a data management method for mobile devices of the invention;

FIG. 5A shows an embodiment of a scale space being created using a difference of Gaussian (DoG) filter of the invention;

FIG. 5B shows an example of candidate points being retrieved in the scale space of FIG. 5A; and

FIG. 6 shows an embodiment of an example for calculating feature vectors corresponding to feature points of the invention.

### DETAILED DESCRIPTION OF THE INVENTION

Data management systems and methods for mobile devices are provided.

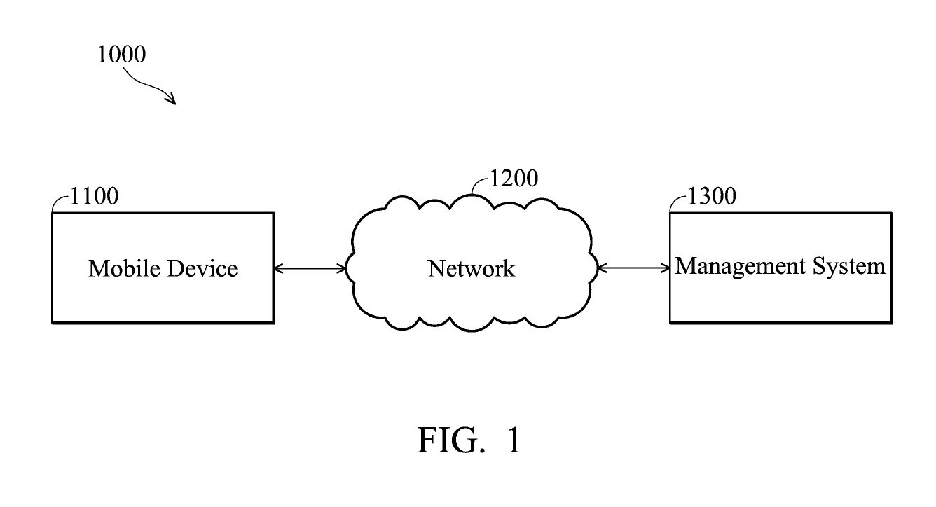

FIG. 1 is a schematic diagram illustrating an embodiment of a data management system for mobile devices of the invention. The data management system for mobile devices 1000 comprises at least one mobile device 1100 and a management system 1300. The mobile device 1100 can connect to the management system 1300 via a network 1200. It is understood that, the network 1200 may be a wired network, a wireless network, or a telecommunication network.

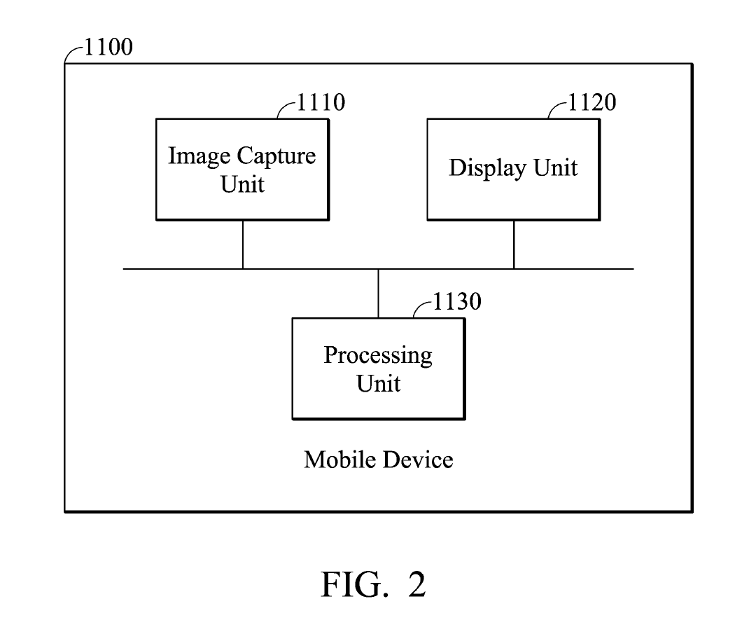

FIG. 2 is a schematic diagram illustrating an embodiment of a mobile device of the invention. The mobile device 1100 may be a processor-based electronic device, such as a portable device comprising a PDA (Personal Digital Assistant), a mobile phone, and a device with mobile networking capabilities. The mobile device 1100 comprises at least an image capture unit 1110, a display unit 1120, and a processing unit 1130. The image capture unit 1110 can capture an image. It is understood that, in some embodiments, the image capture unit 1110 may be a digital camera which is used to shoot an object, a scene, or a picture, thereby capturing a corresponding image. The display unit 1120 can display related data, figures, and interfaces of the captured image. The processing unit 1130 can control and perform operations of the hardware and software of the mobile device 1100. In some embodiments, the processing unit 1130 can transmit the image captured by the image capture unit 1110 to a management system 1300 via a network 1200.

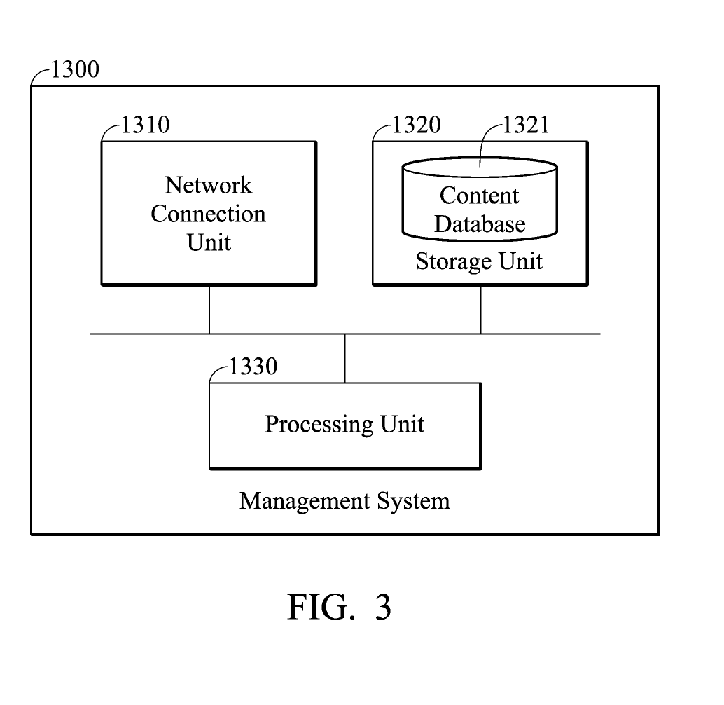

FIG. 3 is a schematic diagram illustrating an embodiment of a management system of the invention. The management system 1300 may be a processor-based electronic device, such as a computer system, a server, and a workstation. The management system 1300 comprises at least a network connection unit 1310, a storage unit 1320, and a processing unit 1330. The network connection unit 1310 enables the management system 1300 for networking capabilities, such that the management system 1300 can receive and transmit data from the network 1200. The storage unit 1320 comprises at least a content database 1321. The content database 1321 records images and/or image features, and data corresponding to respective images and/or image features. It is understood that, in some embodiments, the data may be advertising information, product information, marketing/promotion information, coupon information, and/or digital content information. The processing unit 1330 can control and perform operations of the hardware and software on the management system 1300. In some embodiments, the processing unit 1330 can perform the data management method for mobile devices of the invention, which will be discussed further in the following paragraphs.

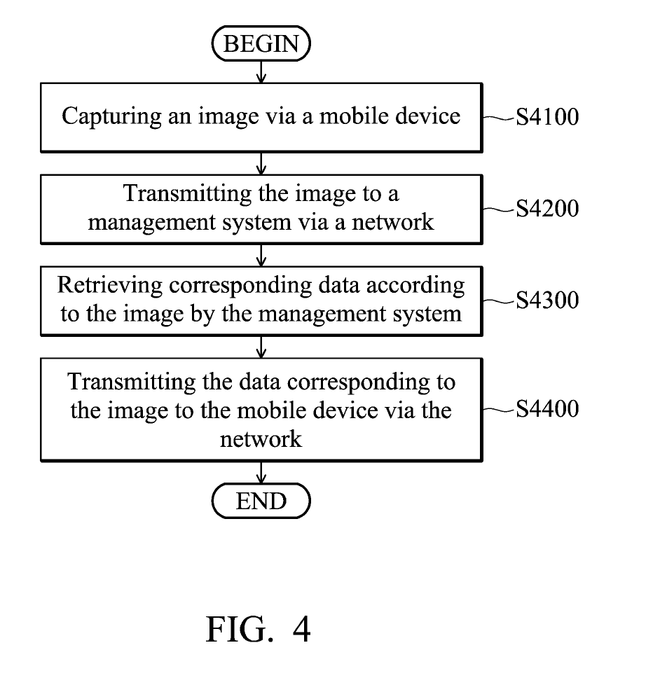

FIG. 4 is a flowchart of an embodiment of a data management method for mobile devices of the invention.

In step S4100, an image is captured by the image capture unit of the mobile device. Similarly, in some embodiments, the image capture unit can shoot an object, a scene, or a picture, thereby capturing a corresponding image. In step S4200, the mobile device automatically transmits the image to the management system via a network. It is understood that, in some embodiments, before the image is transmitted to the management system, the mobile device can first pack the image as a message with a specific format, and transmit the message to the management system via the network. In some embodiments, the specific format may be a short message service (SMS), multimedia message service (MMS), and/or email service format. However, note that the present invention is not limited thereto, and any message format can be applied in the present invention.

After the image is received, in step S4300, the management system retrieves data corresponding to the image from the content database according to the image. As described above, the content database can record images and/or image features, and data corresponding to respective images and/or image features. The data may be advertising information, product information, marketing/promotion information, coupon information, and/or digital content information. It is understood that, in some embodiments, the management system can calculate a specific image feature of the image according to an image recognition algorithm, and retrieve data corresponding to the image from the content database according to the specific image feature. In some embodiments, the image recognition algorithm may be a scale invariant feature transformation (SIFT), speeded up robust feature (SURF), gradient location and orientation histogram (GLOH), or others. However, it is understood that the present invention is not limited thereto, and any image recognition algorithm can be applied to the present invention.

As an example, the image recognition procedure is depicted using the SIFT algorithm. Based on SIFT, the image recognition procedure has four steps:

1) Detection of Scale-Space Extrema:

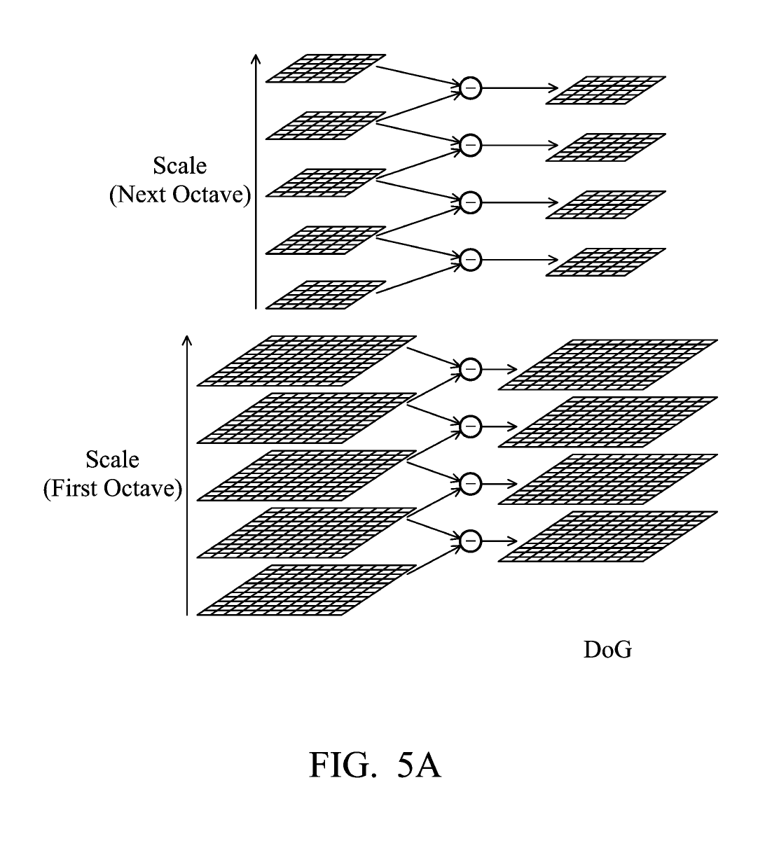

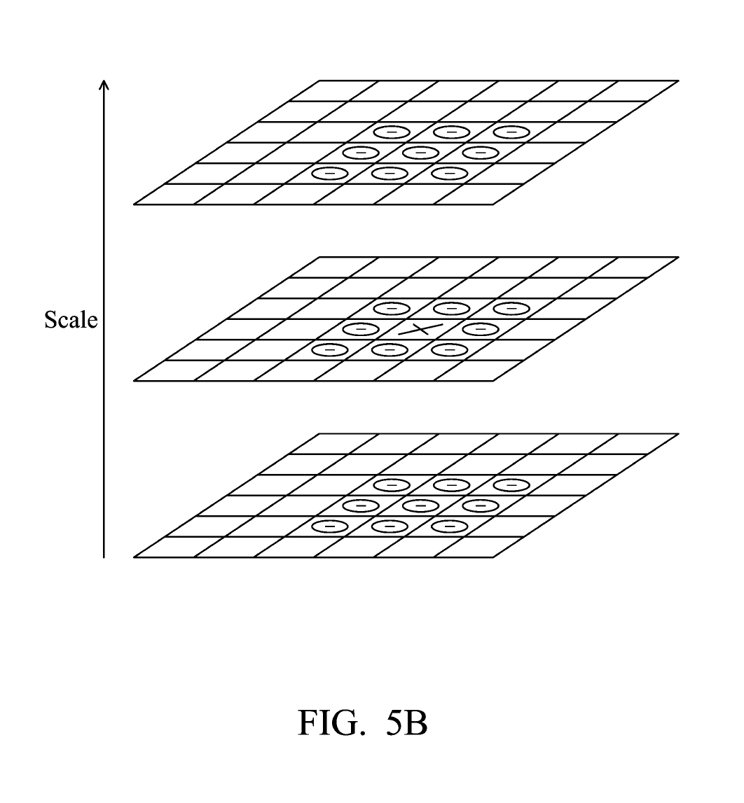

Since the difference of Gaussian (DoG) filters is convenient and fast for calculations, and the effect of a DoG filter is similar to that of a Laplacian of Gaussian (LoG) filter, the DoG filter is used in this embodiment to scale the space. First, a scale space is created using the DoG filter, as shown in FIG. 5A. In FIG. 5A, the standard difference of each octave in the image is doubled. Since the standard difference is doubled, the sampling rate can be reduced to a half, such that the resolution of the image can be lowered from 512*512 to 256*256. The scale space is created when all octaves have been processed. Since the samples of each octave may be not enough, each octave can be further divided into s layers (s is 5 in this embodiment), wherein the scale between two adjacent layers is 2^{1/S}, such that the standard difference of an octave is twice that corresponding to a preceding octave. After the scale space is created, the value of DoG of each image point and its adjacent 26 points (image points marked using circles in FIG. 5B, including 9 points in the upper layer, 8 points in the current (middle) layer, and 9 points in the lower layer) for each octave are respectively compared to find a local maximum and minimum point, wherein the local maximum or minimum points may be the candidate points of feature points of the image.

2) Accurate Feature Point Localization:

After the candidate points are found, unstable candidate points are filtered and deleted. First, the location of the global maximum and minimum points are found by differentiating the feature points, wherein the candidate points are input to the Taylor series:

$$D ( x ) = D + \frac{\partial {D}^{T}}{\partial x} x + \frac{1}{2} {x}^{T} \frac{{\partial }^{2} D}{\partial {x}^{2}} x , \qquad ( 1 )$$

wherein x is the feature point, D is the value of Gaussian difference corresponding to the feature point, and the other symbols represent related expressions of the first order and the second order differentials. When the result of the Taylor series is less than a first threshold value, the candidate point can be considered as a feature point having a low contrast, and therefore be deleted. Next, a ratio of the traces to the determinant is calculated using a 2*2 Hessian matrix. When the ratio is less than a second threshold value, the candidate point can be considered to be located on a border, and therefore be deleted. Thus, proper feature points can be obtained from the candidate points.

3) Orientation Assignment:

In image matching, the orientation of most feature points must first be determined, and all images in the content database must be rotated to a determined orientation for subsequent matching, such that the effect of rotation invariant can be maintained. Therefore, the objective of this step is to calculate the magnitude and the direction of the gradient corresponding to the feature point obtained in the previous step using formula (2):

θ(x,y)=tan⁻¹((L(x,y+1)−L(x,y−1))/(L(x+1,y)−L(x−1,y))) (2),

wherein L is the representative image corresponding to the Gaussian difference, and L(x,y) is the pixel of the image. In this embodiment, an orientation histogram is used as a reference for the gradient directions of points in a window adjacent to each feature point, wherein the directions of most points can be determined as the direction of the feature point.

4) Local Image Descriptor:

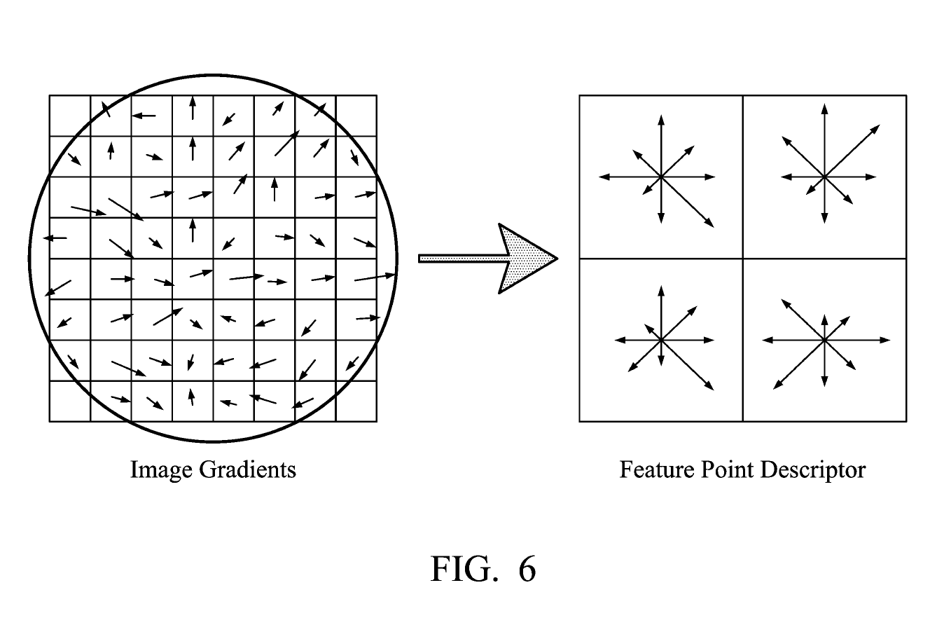

After feature points and corresponding scale, direction and position are obtained, a feature vector is respectively calculated for the feature points, wherein the feature vector can be used for subsequent image matching. Since an error may exist when a single point is used for calculation, a representative feature vector can be calculated using points in a region in this embodiment. As shown in FIG. 6, the 8*8 window adjacent to each feature point is divided into 2*2 sub-windows, and the orientation histograms corresponding to respective sub-windows are calculated to obtain a plurality of feature vectors. After acquiring the image feature, such as the feature vector of the image is obtained, the data corresponding to the image can be retrieved from the content database according to the image feature.

It is understood that, in the above embodiment, the content database can record images and/or image features, and data corresponding to respective images and/or image features. However, in some embodiments, the images and/or image features can be independently stored in an image database. In these embodiments, a corresponding object can be retrieved from the image database according to the feature vector of the image, and the data corresponding to the image can be retrieved from the content database according to the object. Additionally, in order to increase the efficiency of data retrieval, in some embodiments, the images in the image database can be stored according to predefined classifications. During the data retrieval, a specific classification can be first determined according to the feature vector, and then the object is retrieved from the specific classification of the image database. Note that the above embodiment is depicted using the SIFT algorithm. However, the present invention is not limited thereto, and any image recognition algorithm can be applied in the present invention. Additionally, it is also understood that, in some embodiments, before the image is recognized, the management system can perform a pre-processing operation to increase the accurate recognition rate of the image. In some embodiments, the pre-processing operation may be a step of filtering noises from the image using a median filter.

Next, in step S4400, the management system transmits the data corresponding to the image to the mobile device via the network. In some embodiments, after the data corresponding to the image is received, the mobile device can display the data corresponding to the image in the display unit. It is understood that, in some embodiments, the management system can record identification information, such as an email address, a phone number and/or user information corresponding to the mobile device, and transmitted data, for subsequent management processes. For example, related information can be used to analyze user behavior of the mobile device and/or marketing efficiency.

Additionally, in some embodiments, data providers, such as advertising companies can query download records corresponding to related data via a management interface (not shown in FIG. 3) for subsequent analysis. In some embodiments, the data providers can also perform management processes, such as uploading, updating and/or deleting data in the content database via the management interface.

Therefore, the data management systems and methods for mobile devices of the invention can retrieve corresponding data according to the image captured by the mobile device via a network. Data management, such as for advertising information, can be performed based on user requirements, thus increasing the efficiency of data management and reducing the waste of resource usage.

Data management methods for mobile devices, or certain aspects or portions thereof, may take the form of a program code (i.e., executable instructions) embodied in tangible media, such as floppy diskettes, CD-ROMs, hard drives, or any other machine-readable storage medium, wherein, when the program code is loaded into and executed by a machine, such as a computer, the machine thereby becomes an apparatus for practicing the methods. When implemented on a general-purpose processor, the program code combines with the processor to provide a unique apparatus that operates analogously to the application of specific logic circuits.

While the invention has been described by virtue of examples and in terms of preferred embodiments, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data management system for a mobile device, comprising:
a management system comprising a processing unit for receiving an image from a mobile device via a network, retrieving data corresponding to the image according to the received image, and transmitting the data corresponding to the image to the mobile device via the network.

2. The system of claim 1, wherein the mobile device comprising:
an image capture unit capturing the image; and
a processing unit transmitting the image via the network.

3. The system of claim 1, wherein the network comprises a wired network, a wireless network, or a telecommunication network.

4. The system of claim 1, wherein the processing unit further packs the image as a message with a specific format, and transmits the message to the management system via the network.

5. The system of claim 4, wherein the specific format is a short message service (SMS), multimedia message service (MMS), or email service format.

6. The system of claim 1, wherein the management system further comprises a content database for storing data corresponding to respective image features, and the processing unit of the management system further calculates a specific image feature corresponding to the image, and retrieves the data corresponding to the image from the content database according to the specific image feature.

7. The system of claim 5, wherein the processing unit of the management system recognizes the image using an image recognition algorithm, to obtain the specific image feature corresponding to the image.

8. The system of claim 6, wherein before the image is recognized, the processing unit of the management system further performs a pre-processing operation on the image to filter out noises from the image.

9. The system of claim 1, wherein the processing unit of the management system further records identification information of the mobile device and the data corresponding to the image.

10. The system of claim 1, wherein the mobile device further comprises a display unit for displaying the received data.

11. The system of claim 1, wherein the image capture unit comprises a digital camera.

12. A data management method for mobile devices, comprising:
capturing an image via a mobile device;
transmitting the image to a management system via a network by the mobile device;
retrieving data corresponding to the image according to the received image by the management system; and
transmitting the data corresponding to the image to the mobile device via the network by the management system.

13. The method of claim 12, wherein the network comprises a wired network, a wireless network, or a telecommunication network.

14. The method of claim 12, further comprising:
packing the image as a message with a specific format by the mobile device; and
transmitting the message to the management system via the network by the mobile device.

15. The method of claim 14, wherein the specific format is a short message service (SMS), multimedia message service (MMS), or email service format.

16. The method of claim 12, further comprising:
calculating a specific image feature corresponding to the image; and
retrieving data corresponding to the image from a content database according to the specific image feature, wherein the content database stores data corresponding to respective image features.

17. The method of claim 16, wherein the management system recognizes the image using an image recognition algorithm, to obtain the specific image feature corresponding to the image.

18. The method of claim 17, wherein before the image is recognized, the management system further performs a pre-processing operation on the image, thus to filter out noises from the image.

19. The method of claim 12, further comprising recording identification information of the mobile device and the data corresponding to the image.

20. The method of claim 12, further comprising displaying the received data via a display unit after the data is received by the mobile device.
